(19) United States
(12) Patent Application Publication
(10) Pub. No.: US 2003/0121556 A1
(43) Pub. Date: Jul. 3, 2003

(54) Rolling air flow sluice valve

(76) Inventors: Hsu-Cheng Chiang, Hsinchu Hsien (TW); Chien-Chang Hung, Hsinchu Hsien (TW); His-Sheng Wu, Hsinchu Hsien (TW)

Correspondence Address: BIRCH STEWART KOLASCH & BIRCH, PO BOX 747, FALLS CHURCH, VA, 22040-0747, US

(21) Appl. No.: 10/177,150

(22) Filed: Jun. 24, 2002

(30) Foreign Application Priority Data
Dec. 28, 2001 (TW) 90223540

(51) Int. Cl. F16K 3/00

(52) U.S. Cl. 137/872

(57) ABSTRACT

A rolling air flow sluice valve is installed in an air passage of an air supply apparatus, and consists of a plurality of plate elements connected together. The air flow sluice valve is pliable and may be rolled. It is movable across the cross section of the air passage, and may be driven by a traction mechanism to selectively block or alter the air flow passage to achieve the objects of blocking air flow, and changing air flow direction and air outflow patterns.

### FIELD OF THE INVENTION

The invention relates to an element for an air supply apparatus and particularly to a rolling air flow sluice valve installed in an air passage of an air supply apparatus for blocking air flow or altering the direction of air flow.

### BACKGROUND OF THE INVENTION

Conventional air supply apparatus such as air cleaners, air conditioners, dehumidifiers and the like generally have air flow patterns targeting an unspecific area (such as a room) to circulate air. Such air supply apparatus usually have a narrow air outlet to achieve a higher air outflow speed and a greater air ejection range to create a better air blending effect. Top end ejection outflow is such an air flow pattern that is widely adopted.

In recent years there are some air supply apparatus that are mainly aimed at processing air in a selected and limited area. Their air flow outlets have a larger size to allow processed air to flow through in a laminar-flow pattern at a lower speed to achieve even and smooth air circulation. Air processing is focused on the area extending from the air outlet. Such an air flow pattern can control air in the selected area under the required conditions, such as cleanness, temperature and humidity, air flow speed, even air flow distribution, etc. Moreover, such a design can eliminate ineffective work outside the targeted area.

Air outlets of air supply apparatus generally adopt a fixed design, such as a partial opening directed outwards on the casing of the apparatus. The outlets must match established air passages in the air supply apparatus, and cannot be separated or substituted. If there is a need to generate different types of air outflow, other equipment for generating the required air outflow must be developed. This incurs additional development costs. On the other hand, a fixed air outlet can provide only a single type of air outflow, and cannot be replaced to meet different requirements. To meet different air delivery requirements, users have to procure additional equipment.

### SUMMARY OF THE INVENTION

The primary object of the invention is to provide a rolling air flow sluice valve that is capable of changing outflow types and outflow directions of air flow.

The invention provides an air flow sluice valve for generating the two air flow patterns mentioned above to supply a large area in a non-specific range and a limited area in a specific range. The rolling air flow sluice valve of the invention may be installed in the air outlet of an air supply apparatus to change blocking positions of air flow passages and cross section dimensions of the air flow passages thereby to adjust air flow velocity. It can even provide air outflow type selection such as high speed ejection outflow or low speed laminar-flow to allow existing air supply apparatus to generate two types of air outflow. Thus a simple rolling sluice valve may be adopted on the same apparatus to change air outflow types to suit requirements of different circumstances to enhance product functionality.

The rolling air flow sluice valve of the invention basically consists of a plurality of elongated and connected plates. The air flow sluice valve may be rolled or turned to alter the air flow pattern. Compared with conventional air flow valves made from a plurality of small vanes, the invention offers more benefits in terms of cost reduction, air tightness, operational convenience and external appearance.

The foregoing, as well as additional objects, features and advantages of the invention will be more readily apparent from the following detailed description, which proceeds with reference to the accompanying drawings. The drawings are only to serve for reference and illustrative purposes, and are not intended to limit the scope of the invention.

### BRIEF DESCRIPTION OF THE DRAWINGS

FIG. 1 is a perspective view of a sluice valve of the invention.

FIG. 2 is a cross section taken along line II-II in FIG. 1.

FIG. 3A and 3B are schematic views of two embodiments of a traction mechanism of the invention.

FIGS. 4 through 7 are schematic views of the structure of a first embodiment of the rolling air flow sluice valve of the invention.

FIGS. 8A and 8B are schematic views of two embodiments of a guiding mechanism of the invention.

FIGS. 9, 10 and 11 are schematic views of the structure of a second embodiment of the rolling air flow sluice valve of the invention.

FIG. 12 is a schematic view of the structure of a third embodiment of the rolling air flow sluice valve of the invention.

### DESCRIPTION OF THE PREFERRED EMBODIMENTS

The rolling air flow sluice valve of the invention consists of:

A sluice valve 10 made from a plurality of elongated plates 11 connected with one another. The sluice valve 10 is pliable and may be rolled for collection. The sluice valve 10 is installed in an air passage of an air supply apparatus and is movable to change air outflow patterns and outflow directions, or to completely block the air passage.

A traction mechanism 20 installed in the air supply apparatus for moving the sluice valve 10.

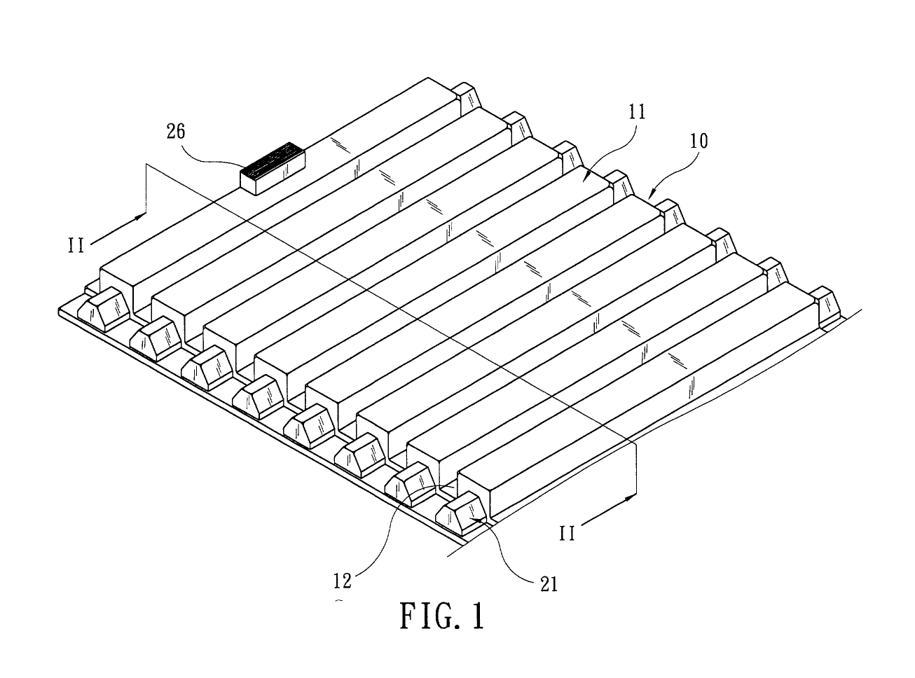

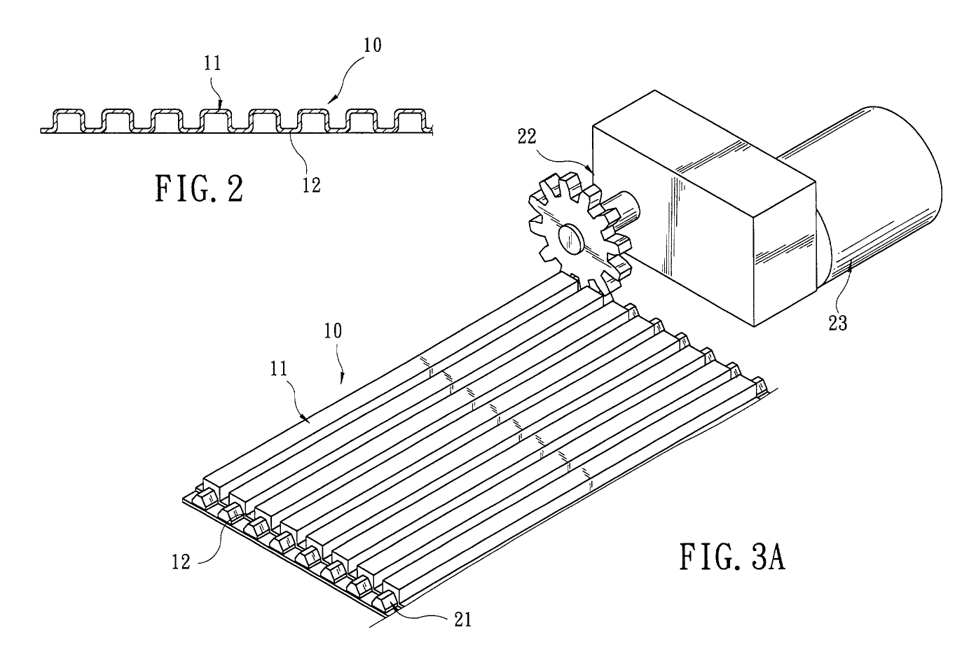

Referring to FIG. 1 for a preferred embodiment, the sluice valve 10 is made from an elastic and pliable material (such as plastic, i.e. PP, PE) by hot rolling processes, injection modeling, etc. With hot rollers, the flat plastic sheets may be pressed to form the sluice valve 10 with a jutting and indented cross section (as shown in FIG. 2). Any two neighboring jutting sections connect to an indented section 12. The jutting sections form the elongated plates 11 and provide sufficient rigidity to allow the sluice valve 10 to withstand transverse pressure, especially air pressure resulting from air flow. The indented sections 12 have extension properties to allow the sluice valve 10 to roll or wind within a selected curvature.

The embodiment of the traction mechanism 20 may include the following types:

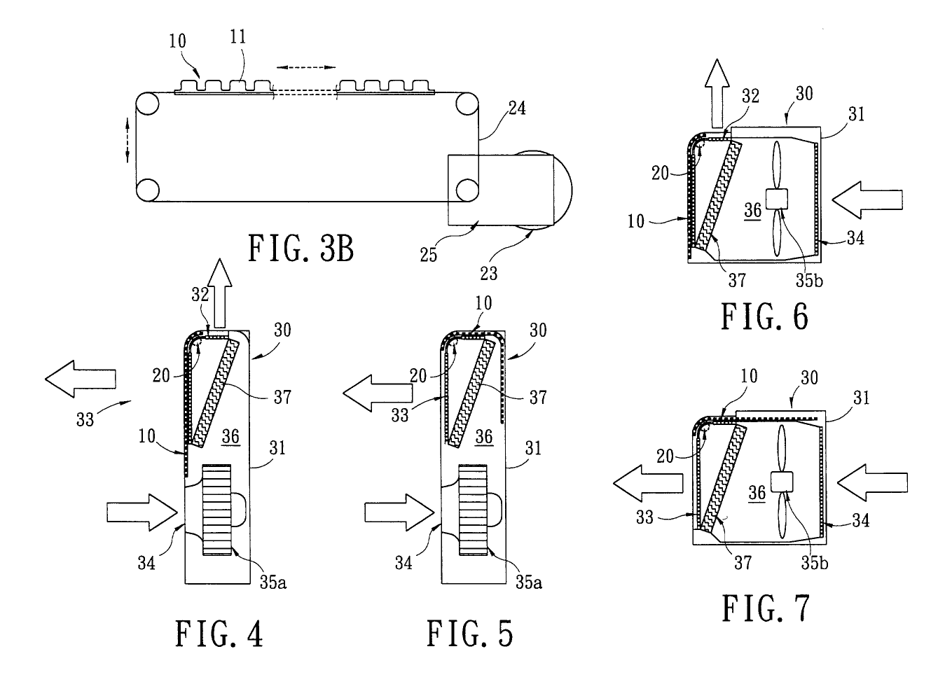

The first type employs gears and gear racks (as shown in FIG. 3A). For instance, two side edges of the sluice valve 10 may be respectively deployed with a gear rack 21, which is engaged with a reduction gear mechanism 22. The reduction gear mechanism 22 may be driven by a motor 23 to move the gear rack 21 of the sluice valve 21, and consequently move the sluice valve 10.

The second type employs a rope and a motor (as shown in FIG. 3B). For instance, a rope 24 with two ends is provided to fasten respectively to two ends of the sluice valve 10 in the direction of motion. Then a motor 23 and a reduction mechanism 25 are provided to drive the rope 24 for moving the sluice valve 10 as desired.

The third type is to move the sluice valve 10 manually. In this embodiment, the sluice valve 10 has a hand grip 26 fixedly mounted thereon at a selected location (as shown in FIG. 1). The hand grip 26 is exposed to allow people to grasp and move the sluice valve 10. Or, a rotation element may be provided to couple with a gear to allow users to turn the sluice valve 10 open or closed.

Various embodiments may be adopted to install the rolling air flow sluice valve in an air supply apparatus. The following describes some of the embodiments.

First Embodiment

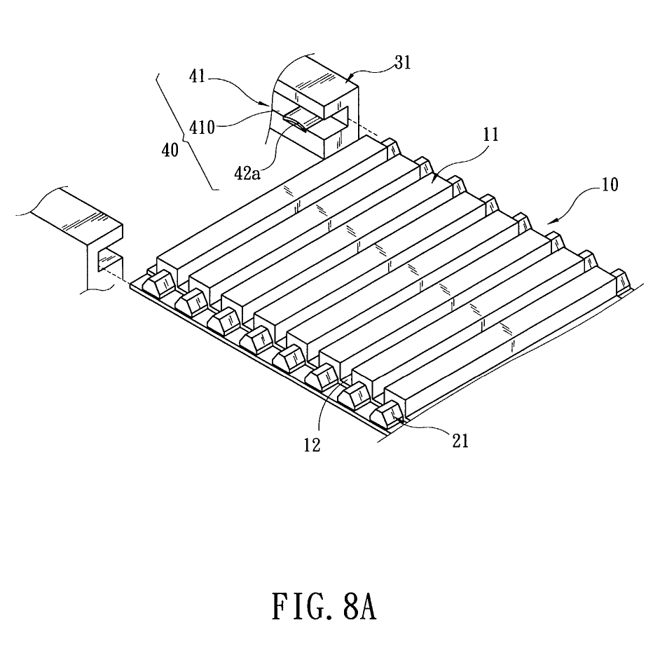

Referring to FIG. 4, the air supply apparatus 30 has two air outlets, an ejection outlet 32 located on the top surface of a casing 31 of the air supply apparatus 30, and a laminar-flow outlet 33 located on the front side of the casing 31. The ejection outlet 32 may provide a higher air outflow speed in an ejection fashion. The laminar-flow outlet 33 provides a lower air outflow speed in an even and level fashion. The casing 31 further has an air suction opening 34 for drawing indoor air into the air supply apparatus 30 by means of a fan located in the casing 31 (such as a centrifugal fan 35a shown in FIGS. 4 and 5, or an axial flow fan 35b shown in FIGS. 6 and 7). Air being drawn flows through an air passage 36, passes through an air processing unit 37, and is then discharged through the ejection outlet 32 or laminar-flow outlet 33 into the room. Depending on machine types and utilization of the air supply apparatus 30, the air processing units 37 may be heat exchangers for heating or cooling air passing through, or filters (such as mechanical filters or chemical filters, or other electronic air cleaning elements such as ozone generators). Of course, the air processing units 37 may also be a combination of heat exchangers and filters.

In this embodiment, the rolling air flow sluice valve may be installed in the casing 31 of the air supply apparatus 30, and is moved by the driving of the traction mechanism 20 to selectively block either the ejection outlet 32 or laminar-flow outlet 33 so that the air supply apparatus 30 can discharge air flow at a higher speed in an ejection fashion (shown in FIGS. 4 and 6), or at a lower speed in an even and smooth air flow fashion (shown in FIGS. 5 and 7).

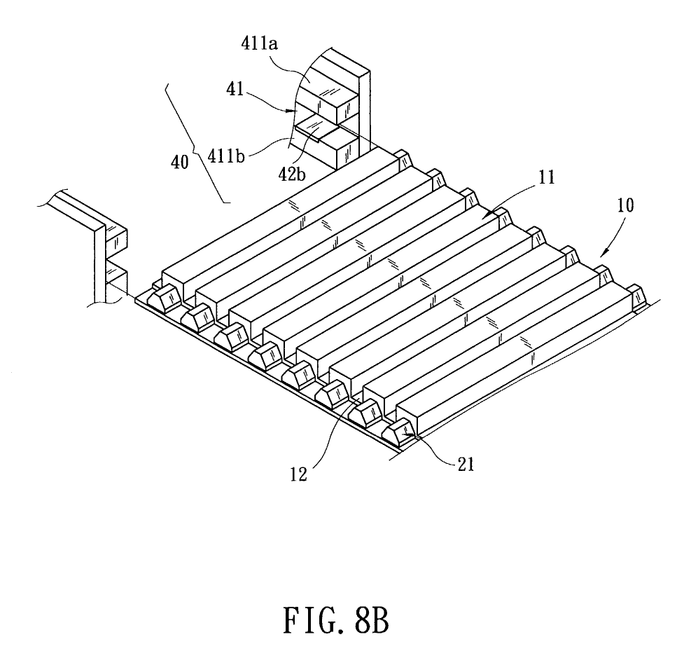

To match the rolling sluice valve 10 set forth above, the casing 31 of the air supply apparatus 30 should provide a guiding mechanism 40. A preferred design is to provide rails 41 in the casing 31 on locations corresponding to two sides of the sluice valve 10. The rail 41 may be made by forming an indented groove 410 on each of two sides of the casing 31 (as shown in FIG. 8A), or by mounting two jutting and parallel ribs 411a and 411b on each of the two sides of the casing 31 (as shown in FIG. 8B). Thus two sides of the sluice valve 10 are restricted by the rails 41, and the sluice valve 10 is moved by the driving of the traction mechanism 20.

On the inner rim of the rail 41 or indented groove 410, a suitable frictional element (such as a bulging elastic strip 42a or a cushion pad 42b, as shown in FIGS. 8A and 8B) may also be provided and mounted to give the sluice valve 10 desired resistance while moving to prevent the sluice valve 10 from inadvertently moving under its own weight when external force is absent.

In the event that the sluice valve 10 has a greater width and the elongated plates 11 do not have sufficient strength to withstand transverse pressure, the cross section of the sluice valve should be made smaller, or reinforced ribs should be added to make the structure of the sluice valve stronger.

Second Embodiment

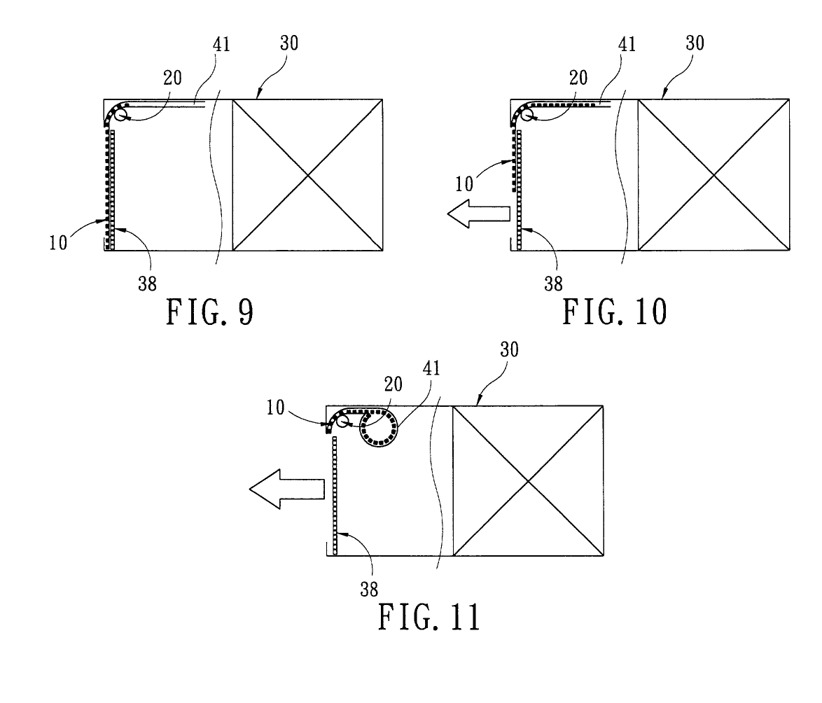

Referring to FIGS. 9, 10 and 11, the air supply apparatus 30 has a single air outlet 38. Such an air supply apparatus 30 may be connected to the end of the air delivery piping of a central air conditioning system. The sluice valve 10 of the invention is installed on the exterior of the air outlet 38, and is also driven by a traction mechanism 20. The surface of the casing 31 has a guide rail 41 laid along a desired moving path for the sluice valve 10. When the sluice valve 10 is driven by the traction mechanism 20 and moved to a location to completely block the air outlet 38 (as shown in FIG. 9), the air flow passage is blocked. Air supply is then cut off. In addition, blocking the air outlet 38 also can prevent external objects from entering into the air supply apparatus when the air supply apparatus is shut down or stops operating . The air outlet 38 shielded by the sluice valve 10 also looks more attractive .

In addition, through the traction mechanism 20, the sluice valve 10 may be moved freely to control the size of the air outlet 38, thereby altering air flow velocity and air flow pattern (as shown in FIG. 10). As the sluice valve 10 is pliable, through proper design of the moving path of the guide rail 41, the sluice valve 38 moving away from the air outlet 38 may be wound and rolled in the casing 31 of the air supply apparatus 30 (as shown in FIG. 11).

Third Embodiment

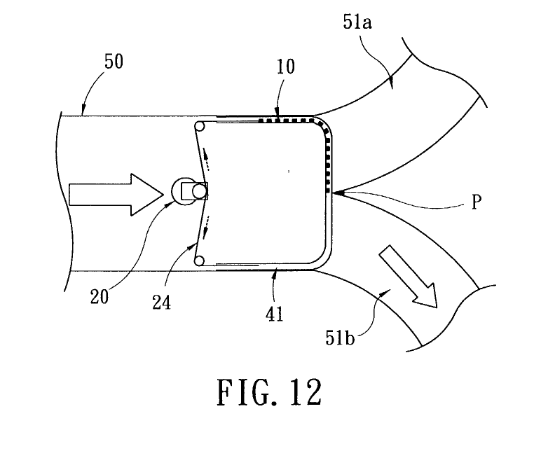

In this embodiment the rolling air flow sluice valve may be installed in an air intake pipe 50 of an air supply apparatus, especially in the air intake manifold pipes 51a and 51b. The sluice valve 10 is located on an upstream location beyond the bifurcation P of the air intake pipe 50 (as shown in FIG. 12). Under the driving of the traction mechanism 20, the sluice valve 10 may be moved to channel air flow to a selected manifold (51a or 51b), or completely block the air passage. Furthermore, the sluice valve 10 may be made from fireproof materials such as metals (aluminum or the like) to meet fireproof safety standards and requirements. The sluice valve 10 made of metal may be constructed like conventional metal rolling doors, which consist of a plurality of metal sheets pivotally engaged with one another.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A rolling air flow sluice valve being installed in an air supply apparatus, comprising:
a sluice valve including a plurality of elongated plates connecting together and being pliable to allow rolling for collection, and being movably installed in the air passage of the air supply apparatus;
a guiding mechanism located in the air supply apparatus for guiding movement of the sluice valve; and
a traction mechanism installed in the air supply apparatus for moving the sluice valve.

2. The rolling air flow sluice valve of claim 1, wherein the sluice valve is made from a pliable thin plastic sheet and has a cross section formed with a plurality of jutting sections and indented sections, any two neighboring jutting sections being connected to one indented section.

3. The rolling air flow sluice valve of claim 1, wherein the sluice valve is installed on a exterior of an air outlet of the air passage, and is movable to completely block the air outlet, or partly block the air outlet, or not block the air outlet.

4. The rolling air flow sluice valve of claim 1, wherein the sluice valve is installed on a exterior of an air outlet of the air passage, the air outlet including an ejection outlet and a laminar-flow outlet, and the sluice valve being movable to completely block the air outlet or to block the ejection outlet or the laminar-flow outlet.

5. The rolling air flow sluice valve of claim 1, wherein the sluice valve is installed on an upstream location beyond a bifurcation of the air passage, the sluice valve being movable to completely block the air passage or to allow air flow entering into a selected air passage.

6. The rolling air flow sluice valve of claim 1, wherein the guiding mechanism is a rail located on the exterior surface of a casing of the air supply apparatus corresponding to two sides of the sluice valve.

7. The rolling air flow sluice valve of claim 6, wherein the rail is an indented groove formed on the surface of the casing.

8. The rolling air flow sluice valve of claim 6, wherein the rail is two parallel jutting ribs located on the surface of the casing.

9. The rolling air flow sluice valve of claim 6, wherein the rail has a friction element to provide resistant force during the sluice valve being moved.

10. The rolling air flow sluice valve of claim 1, wherein the traction mechanism includes:
a gear rack located on each of two side edges of the sluice valve;
a gear reduction mechanism engageable with the gear rack; and
a motor for driving the gear reduction mechanism.

11. The rolling air flow sluice valve of claim 1, wherein the traction mechanism includes:
a rope having two ends fastened respectively two ends of the sluice valve;
a reduction mechanism to pull the rope; and
a motor for driving the reduction mechanism.

12. The rolling air flow sluice valve of claim 1, wherein the traction mechanism is a hand grip located and exposed on an exterior location of the air supply apparatus.
